(19) United States
(12) Patent Application Publication
(10) Pub. No.: US 2018/0050489 A1
(43) Pub. Date: Feb. 22, 2018

(54) SHAPING DEVICE AND SHAPING METHOD

(71) Applicant: MIMAKI ENGINEERING CO., LTD., Nagano (JP)

(72) Inventors: Masakatsu OKAWA, Nagano (JP); Kazuhiro OCHI, Nagano (JP)

(73) Assignee: MIMAKI ENGINEERING CO., LTD., Nagano (JP)

(21) Appl. No.: 15/675,793

(22) Filed: Aug. 14, 2017

(30) Foreign Application Priority Data
Aug. 17, 2016 (JP) 2016-159875

(51) Int. Cl. B29C 64/112; B29C 64/124; B29C 64/188; B41J 2/045

(52) U.S. Cl. CPC B29C 64/112; B29C 64/124; B33Y 30/00; B41J 2/04586; B29C 64/188

(57) ABSTRACT

A shaping device that shapes a three-dimensional (3D) object includes discharging heads that each discharges a material of shaping; and a controller; wherein the discharging heads include at least a black material head that discharges a black material, and a translucent material head that discharges a material having translucency; the controller causes the discharging heads to form a black region colored in black using the black material in at least one part of a portion where a hue is externally identifiable in the 3D object; and the black region includes an inner side region, which is a first region, colored in black using the black material, and a surface side region, which is a second region, covering the inner side region from an outer side, having a higher transmittance of light than the inner side region and formed using at least the material having translucency.

### CROSS REFERENCE TO RELATED APPLICATIONS

This application claims the priority benefit of Japanese Patent Application No. 2016-159875, filed on Aug. 17, 2016. The entirety of the above-mentioned patent application is hereby incorporated by reference herein and made a part of this specification.

### TECHNICAL FIELD

The present disclosure relates to a shaping device and a shaping method.

### DESCRIPTION OF THE BACKGROUND ART

A shaping device (three-dimensional printer (3D printer)) that shapes a three-dimensional object (3D object) using an ink jet head is conventionally known (see e.g., Japanese Laid-Open Patent Publication No. 2015-71282).

In such shaping device, for example, the 3D object is shaped through the layering and shaping method by, for example, layering a plurality of layers of ink with the ink jet head.

### SUMMARY

A case of coloring the 3D object includes, for example, a case of coloring some region in black using a black ink. In such a case, for example, it is sometimes desired to represent deep black such as piano black, and the like for the way black is externally seen. Thus, a configuration that can more appropriately represent such deep black is conventionally desired. The present disclosure thus provides a shaping device and a shaping method that can solve the problem described above.

When carrying out shaping using the ink jet head, consideration is made to shaping a colored 3D object by using the black ink and other inks for coloring to carry out the shaping. In this case, for example, coloring of various colors can be carried out by forming a region of a surface where hue can be visually recognized from the outside with the ink for coloring, and the like.

Furthermore, in this case, the black region formed with the black ink is desirably formed so as to sufficiently absorb the externally entering light. To this end, consideration is made to using a dark black ink for the black ink used to form the black region so as to more reliably absorb light.

However, when forming the black region with the dark black ink, an impression as if only the surface is colored in black is given if the black region is merely formed uniformly, and a deep black may become difficult to represent. More specifically, for example, when attempting to represent piano black, and the like, which is a shiny deep black, an impression that the deepness of the black is insufficient is given, and a high-class piano black, and the like may not be sufficiently represented.

On the contrary, the inventor of the present application considered, after through thorough research, changing the transmittance of the black region in the normal direction of the 3D object, instead of merely forming the black region uniformly. Furthermore, more specifically, consideration is made to making the transmittance of the portion on the outer side, which is the side close to the exterior of the 3D object, higher than the transmittance of the portion on the inner side, which is the side close to the interior of the 3D object, for the black region. Furthermore, for example, it was found that the deep black can be more appropriately represented compared to when simply forming the black region uniformly. Furthermore, the inventor of the present disclosure, through thorough researches, found the features necessary for obtaining such effects, and contrived the present disclosure.

In other words, in order to solve the problem described above, the present disclosure relates to a shaping device that shapes a three-dimensional 3D object, the shaping device including a plurality of discharging heads that each discharges a material of shaping; and a controller that controls operation of the discharging head; where the plurality of discharging heads include at least a black material head that discharges a black material, and a translucent material head that discharges a material having translucency; the controller causes the plurality of discharging heads to form a black region colored in black using the black material in at least one part of a portion where hue is externally identifiable in the 3D object; and the black region includes a first region colored in black using the black material, and a second region covering the first region from an outer side, the region having a higher transmittance of light than the first region and formed using at least the material having translucency.

When configured in such manner, for example, the light can be prevented from being absorbed with only the surface of the black region, and the light can enter inside, to a certain extent, of the black region. Furthermore, the light entering through the second region can be appropriately and sufficiently absorbed and black can be represented by forming the first region colored in black on the inner side. Thus, according to such configuration, for example, a deep black can be more appropriately represented in the black region.

In such a configuration, the black region is, for example, a region where a portion of greater than or equal to a predetermined area in the surface is filled in black. In the relevant configuration, black merely needs to be, for example, substantially black according to the demanded accuracy of coloring. Furthermore, black is, for example, is a color of an achromatic color having light absorbing property.

Furthermore, the black region may be a region of one part specified by the user or the shaping data of the portion colored in black in the 3D object. Thus, when coloring one part of the coloring region in black, for example, such portion may be considered as one part of the coloring region rather than as the black region.

Furthermore, in such a configuration, the second region is, for example, a colorless transparent region. The second region may be a region colored to a lighter black than the first region. The black region may, for example, be formed to a gradation form of gradually changing to a dark black from the outer side toward the inner side. In this case, for example, one portion on the inner side of the black region can be considered as the first region, and the one portion on the outer side can be considered as the second region.

Consideration is also made to using a shaping method, and the like having a feature similar to the above for the configuration of the present disclosure. In this case as well, for example, effects similar to the above can be obtained. Furthermore, the shaping method can also be considered as, for example, a method for manufacturing the 3D object. Moreover, a configuration of a 3D object shaped with the shaping device or the shaping method can be considered for the configuration of the present disclosure.

### Effects of the Disclosure

According to the present disclosure, for example, a deep black can be more appropriately represented in the shaping device that shapes the 3D object.

### BRIEF DESCRIPTION OF THE DRAWINGS

FIGS. 1A and 1B are views showing one example of a shaping device 10 according to one embodiment of the present disclosure. FIG. 1A shows one example of a configuration of a main part of the shaping device 10. FIG. 1B shows one example of a configuration of a head unit 12 of the shaping device 10.

FIGS. 2A to 2C are views showing one example of a configuration of a 3D object 50 shaped by the shaping device 10. FIG. 2A is a cross-sectional view of one example of the configuration of the 3D object 50. FIG. 2B is a view describing features, and the like of the black region 308 in further detail. FIG. 2C is a view describing a configuration of the black region 308 in further detail.

FIGS. 3A to 3C are views describing the features of the 3D object 50 in further detail. FIG. 3A shows another example of a configuration of the 3D object 50 shaped by the shaping device 10. FIG. 3B shows a variant of the configuration of the 3D object 50. FIG. 3C shows a further variant of the configuration of the 3D object 50.

FIGS. 4A and 4B are views describing a further variant of the configuration of the 3D object 50. FIGS. 4A and 4B show a further variant of the configuration of the 3D object 50.

### DETAILED DESCRIPTION OF EMBODIMENTS

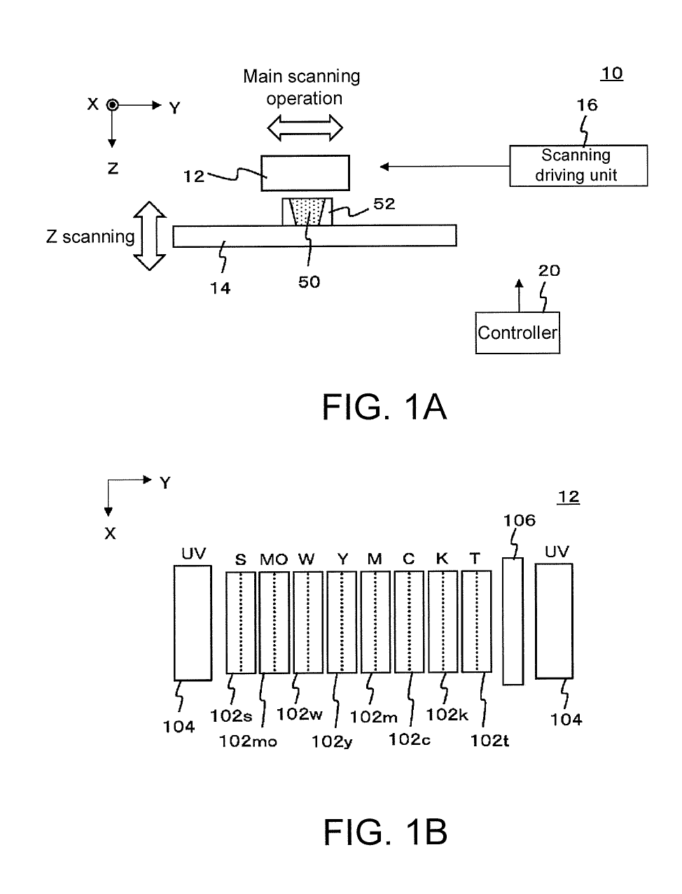

Hereinafter, an embodiment according to the present disclosure will be described with reference to the drawings. FIGS. 1A and 1B show one example of a shaping device 10 according to one embodiment. FIG. 1A shows one example of a configuration of a main part of the shaping device 10. FIG. 1B shows one example of a configuration of a head unit 12 of the shaping device 10.

Excluding the points described below, the shaping device 10 may have a configuration same as or similar to a known shaping device. More specifically, excluding the points described below, the shaping device 10 may have a configuration same as or similar to, for example, a known shaping device that carries out shaping by discharging a liquid droplet to become a material of a 3D object 50 using an ink jet head. Other than the illustrated configuration, for example, the shaping device 10 may also include various types of configurations necessary for shaping, coloring, and the like of the 3D object 50.

In the present example, the shaping device 10 is a shaping device (3D shaping device) that shapes a three-dimensional 3D object 50 through a layering and shaping method. In this case, the layering and shaping method is, for example, a method for shaping the 3D object 50 by overlapping a plurality of layers. In the present example, the shaping device 10 includes a head unit 12, a shaping table 14, a scanning driving unit 16, and a controller 20.

The head unit 12 is a portion that discharges the material of the 3D object 50. In this case, discharging the material of the 3D object 50 refers to, for example, discharging an ink to become the material of the 3D object 50. The ink is, for example, a liquid discharged from the ink jet head. The ink jet head is, for example, a discharging head that discharges the liquid droplet of ink (ink droplet) through an ink jet method.

More specifically, the head unit 12 discharges a liquid droplet of an ink that cures according to a predetermined condition from a plurality of ink jet heads, as the liquid droplet to become the material of the 3D object 50. The landed ink is then cured to form, in an overlapping manner, each layer configuring the 3D object 50. Furthermore, in the present example, an ultraviolet curing type ink (UV ink) that cures from a liquid state when irradiated with an ultraviolet ray is used for the ink.

Furthermore, the head unit 12 further discharges the material of a support layer 52 in addition to the material of the 3D object 50. The shaping device 10 thus forms the support layer 52, as necessary, at a periphery of the 3D object 50. The support layer 52 is, for example, a layered structural object that supports the 3D object 50 by surrounding the outer periphery of the 3D object 50 being shaped. The support layer 52 is formed, as necessary, during the shaping of the 3D object 50, and removed after the shaping is completed. A more specific configuration of the head unit 12 will be described in detail layer.

The shaping table 14 is a table-shaped member that supports the 3D object 50 being shaped and is arranged at a position facing the ink jet head in the head unit 12, where the 3D object 50 being shaped is mounted on an upper surface thereof. Furthermore, in the present example, the shaping table 14 has a configuration in which at least the upper surface is movable in a layering direction (Z direction in the figure), where at least the upper surface moves in accordance with the progress in the shaping of the 3D object 50 by being driven by the scanning driving unit 16. In this case, the layer direction is, for example, a direction in which the material of shaping is layered in the layering and shaping method. More specifically, in the present example, the layering direction is a direction (Z direction in the figure) orthogonal to a main scanning direction (Y direction in the figure) and a sub-scanning direction (X direction in the figure).

The scanning driving unit 16 is a driving unit that causes the head unit 12 to carry out a scanning operation of relatively moving with respect to the 3D object 50 being shaped. In this case, relatively moving with respect to the 3D object 50 being shaped means, for example, relatively moving with respect to the shaping table 14. Furthermore, in the present example, the scanning driving unit 16 causes the head unit 12 to carry out a main scanning operation (Y scanning), a sub-scanning operation (X scanning), and a layering direction scanning (Z scanning).

When referring to causing the head unit 12 to carry out the main scanning operation, this means, for example, causing the ink jet head of the head unit 12 to carry out the main scanning operation. Furthermore, the main scanning operation is, for example, an operation of discharging the ink while moving in the main scanning direction. In the present example, the scanning driving unit 16 causes the head unit 12 to carry out the main scanning operation by fixing the position of the shaping table 14 in the main scanning direction and moving the head unit 12 side. In a variant of the configuration of the shaping device 10, for example, the 3D object 50 side may be moved by fixing the position of the head unit 12 in the main scanning direction and, for example, moving the shaping table 14.

As will be described in detail below, the head unit 12 further includes an ultraviolet light source in the present example. At the time of the main scanning operation, the scanning driving unit 16 further carries out the drive of the ultraviolet light source in the head unit 12. More specifically, the scanning driving unit 16, for example, turns ON the ultraviolet light source at the time of the main scanning operation to cure the ink landed on a surface-to-be-shaped of the 3D object 50. The surface-to-be-shaped of the 3D object 50 refers to, for example, a surface on which a next layer of ink is formed by the head unit 12.

When referring to causing the head unit 12 to carry out the sub-scanning operation, this means, for example, causing the ink jet head of the head unit 12 to carry out the sub-scanning operation. The sub-scanning operation is, for example, an operation of relatively moving with respect to the shaping table 14 in the sub-scanning direction orthogonal to the main scanning direction. The sub-scanning operation may be an operation of relatively moving with respect to the shaping table 14 in the sub-scanning direction by a feeding amount set in advance.

Furthermore, in the present example, the scanning driving unit 16 causes the head unit 12 to carry out the sub-scanning operation between the main scanning operations. In this case, the scanning driving unit 16 causes the head unit 12 to carry out the sub-scanning operation by fixing the position of the head unit 12 in the sub-scanning direction and moving the shaping table 14. Furthermore, the scanning driving unit 16 may cause the head unit 12 to carry out the sub-scanning operation by fixing the position of the shaping table 14 in the sub-scanning direction and moving the head unit 12. The scanning driving unit 16 causes the head unit 12 to carry out the sub-scanning operation, only when necessary, according to the size of the 3D object 50 to shape. Thus, when shaping the 3D object 50 of a small size, and the like, the 3D object 50 may be shaped without carrying out the sub-scanning operation.

When referring to causing the head unit 12 to carry out the layering direction scanning, this means, for example, causing the ink jet head of the head unit 12 to carry out the layering direction scanning. Furthermore, the layering direction scanning is, for example, an operation of relatively moving the head unit 12 in the layering direction with respect to the 3D object 50 by moving at least one of the head unit 12 or the shaping table 14 in the layering direction. In this case, when referring to moving the head unit 12 in the layering direction, for example, this means moving at least the ink jet head in the head unit 12 in the layering direction. Furthermore, moving the shaping table 14 in the layering direction means, for example, moving the position of at least the upper surface in the shaping table 14.

The scanning driving unit 16 changes a head-table distance, which is a distance between the ink jet head in the head unit 12 and the shaping table 14, by causing the head unit 12 to carry out the layering direction scanning in accordance with the progress of the shaping operation. The head-table distance may be, for example, a distance between a nozzle surface, where a nozzle (nozzle hole) is formed in the ink jet head, and the upper surface of the shaping table 14. More specifically, in the present example, the scanning driving unit 16 fixes the position of the head unit 12 in the layering direction, and moves the shaping table 14. The scanning driving unit 16 may fix the position of the shaping table 14 in the layering direction, and move the head unit 12.

The controller 20 is, for example, a CPU of the shaping device 10, and controls each unit of the shaping device 10 to control the shaping operation of the 3D object 50. The controller 20 preferably controls each unit of the shaping device 10 based on, for example, shape information, color image information, and the like of the 3D object 50 to be shaped. According to the present example, the 3D object 50 can be appropriately shaped.

Next, a more specific configuration of the head unit 12 will be described. In the present example, the head unit 12 includes a plurality of ink jet heads. Each ink jet head is an example of a discharging head that respectively discharges the material of shaping, and the like, and includes a nozzle row in which a plurality of nozzles are lined in a predetermined nozzle row direction on a surface facing the shaping table 14. Furthermore, the shaping device 10 shapes the 3D object 50 by discharging the material from the plurality of nozzle rows in the head unit 12.

More specifically, in the present example, the head unit 12 includes a plurality of ink jet heads, a plurality of ultraviolet light sources 104, and a flattening roller 106. As shown in FIG. 1B, the plurality of ink jet heads include an ink jet head 102s, an ink jet head 102mo, an ink jet head 102w, an ink jet head 102y, an ink jet head 102m, an ink jet head 102c, an ink jet head 102k, and an ink jet head 102t. Such plurality of ink jet heads are, for example, arranged lined in the main scanning direction with the positions in the sub-scanning direction aligned.

The ink jet head 102s is an ink jet head (support layer head) that discharges the material (S) of the support layer 52. In the present example, an ultraviolet curing type ink, in which a cure degree by the ultraviolet ray is weaker than the material of the 3D object 50, is used for the material of the support layer 52. Thus, the ink jet head 102s discharges the ultraviolet curing type ink to become the material of the support layer 52 from each nozzle in the nozzle row.

As described above, the support layer 52, for example, supports the 3D object 50 by surrounding the outer periphery of the 3D object 50 being shaped. More specifically, for example, the support layer 52 supports an overhang shape of the 3D object from below to allow the shaping of the 3D object 50 including the overhang portion. Furthermore, for example, consideration is also made to discharging the material of the support layer 52 to a shaping area in the shaping table 14 and forming the support layer 52 to a plate shape, and the like before the start of the shaping operation. According to such configuration, for example, the bumps on the surface of the shaping table 14 are corrected, and the planarity can be more appropriately ensured. A water soluble material that can be dissolved in water after the shaping of the 3D object 50 is preferably used for the material of the support layer 52. In this case, a material o f which cure degree is weaker and which more easily decomposes than the material configuring the 3D object 50 is preferably used. Furthermore, a known material for the support layer, for example, can be suitably used for the material of the support layer 52. According to such configuration, for example, the support layer 52 can be appropriately removed by dissolving, removing, and the like after the shaping is completed.

The ink jet head 102mo is an ink jet head that discharges a shaping material ink (MO ink), and discharges the shaping material ink from each nozzle in the nozzle row. In this case, the shaping material ink is, for example, a shaping dedicated ink used for the shaping of the interior (interior region) of the 3D object 50.

The interior of the 3D object 50 is not limited to being formed with the shaping material ink, and may be formed by further using an ink of another color. Furthermore, for example, consideration is also made to forming the interior of the 3D object 50 with only the ink of another color (e.g., white ink, etc.) without using the shaping material ink. In this case, the ink jet head 102mo may be omitted in the head unit 12.

The ink jet head 102w is an ink jet head that discharges a white (W) ink, and discharges the white ink from each nozzle in the nozzle row. In the present example, the white ink is an example of a material having light reflecting property, and is, for example, used when forming a region (light reflecting region) having a property of reflecting light in the 3D object 50. The light reflecting region, for example, reflects the light entering from outside the 3D object 50 when carrying out coloring in a full color representation by the subtractive color mixing method on the surface of the 3D object 50. The full color representation is, for example, a representation of color carried out with a possible combination of the subtractive color mixing by the inks of the process colors. In the present example, the ink jet head 102w is an example of a light reflective material head that discharges the material having light reflecting property.

The ink jet head 102y, the ink jet head 102m, the ink jet head 102c, and the ink jet head 102k (hereinafter referred to as ink jet heads 102y to 102k) are ink jet heads for decoration (decoration heads) used at the time of shaping of the colored 3D object 50, and respectively discharges the respective ink of a plurality of colors of ink (decoration ink) used for coloring from each nozzle in the nozzle row. More specifically, the ink jet head 102y discharges a yellow (Y) ink. The ink jet head 102m discharges a magenta (M) ink. The ink jet head 102c discharges a cyan (C) ink. The ink jet head 102k discharges a black (K) ink. In this case, each color of YMCK is an example of a process color used for the full color representation.

Furthermore, in the present example, the ink of each color of YMC is an example of a material for coloring of a chromatic color. The black (K) ink is an example of a black material. Among the ink jet heads for decoration, the ink jet head 102y, the ink jet head 102m, and the ink jet head 102c are examples of a coloring material head that discharges the material for coloring of a chromatic color. The ink jet head 102k is an example of a black head that discharges a black material. The ink jet head 102k is an example of a light absorbing material head that discharges a material having light absorbing property.

The ink jet head 102t is an ink jet head that discharges a clear ink, and discharges the clear ink from each nozzle in the nozzle row. The clear ink is, for example, an ink of a clear color or a colorless transparent color (T). In the present example, the clear ink is also an example of a material having translucency. The ink jet head 102t is an example of a translucent material head that discharges the material having translucency.

The plurality of ultraviolet light sources 104 are light sources (UV light sources) for curing the ink, and generate the ultraviolet ray for curing the ultraviolet curing type ink. Furthermore, in the present example, each of the plurality of ultraviolet light sources 104 is arranged at each of one end side and another end side in the main scanning direction in the head unit 12 so as to sandwich the arrangement of the ink jet heads in between. A UVLED (ultraviolet LED), and the like, for example, can be suitably used for the ultraviolet light source 104. Furthermore, consideration is also made to using a metal halide lamp, a mercury lamp, and the like for the ultraviolet light source 104.

The flattening roller 106 has a configuration for flattening the layer of ink formed during the shaping of the 3D object 50. At the time of the main scanning operation, for example, the flattening roller 106 comes into contact with the surface of the layer of ink and removes one part of the ink before being cured, to flatten the layer of ink.

The layer of ink configuring the 3D object 50 can be appropriately formed by using the head unit 12 having the configuration described above. Furthermore, the 3D object 50 can be appropriately shaped by forming the plurality of layers of ink in an overlapping manner.

A specific configuration of the head unit 12 is not limited to the configuration described above, and various modifications can be made. For example, in addition to the ink jet heads 102y to 102k, the head unit 12 may further include ink jet heads for colors such as a light color of each color, R (red), G (green), B (blue), orange, and the like for the ink jet heads for coloring. Furthermore, the manner of arranging the plurality of ink jet heads in the head unit 12 can also be variously modified. For example, the positions in the sub-scanning direction of some ink jet heads may be shifted from the other ink jet heads.

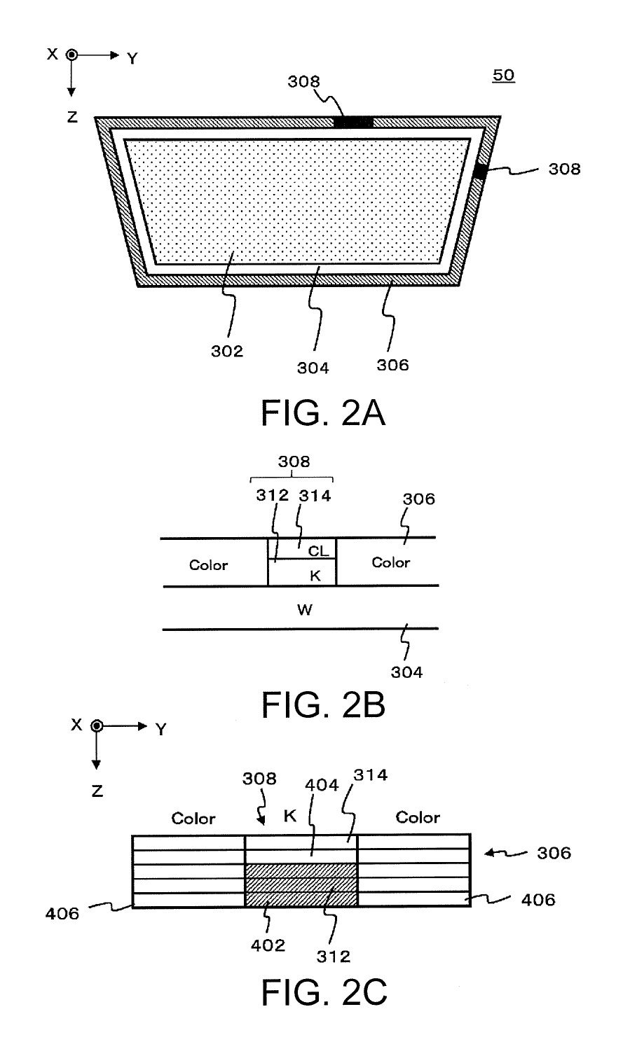

Next, a configuration of the 3D object 50 shaped by the shaping device 10 in the present example will be described. FIG. 2 shows one example of a configuration of the 3D object 50 shaped by the shaping device 10. FIG. 2A is a cross-sectional view of one example of the configuration of the 3D object 50, and shows one example of a cross-section of the 3D object 50 at a plane perpendicular to the sub-scanning direction (X direction) in a simplified manner.

Although the illustration is omitted, the shaping device 10 forms the support layer 52 (see FIGS. 1A and 1B) at the periphery of the 3D object 50, as necessary, at the time of shaping. For example, a cross-section at a plane perpendicular to the main scanning direction and the layering direction also has a region configuration similar to the case shown in FIG. 2A.

In the present example, the shaping device 10 can shape the 3D object 50 in which at least one part of a portion where hue can be externally identified is colored. Furthermore, when shaping such colored 3D object 50, for example, the shaping device 10 shapes the 3D object 50 including an interior region 302, a light reflecting region 304, a coloring region 306, and a black region 308, as in the illustrated configuration. In such a case, the controller 20 (see FIGS. 1A and 1B) of the shaping device 10 causes each ink jet head of the head unit 12 (see FIGS. 1A and 1B) to discharge various types of ink to form each region of the 3D object 50.

The interior region 302 is a region configuring the interior of the 3D object 50. The interior region 302 may, for example, be considered as a region configuring the shape of the 3D object 50. In the present example, the shaping device 10 forms the interior region 302 by, for example, forming the layer of shaping material ink discharged from the ink jet head 102mo (see FIGS. 1A and 1B) in an overlapping manner. Furthermore, the shaping device 10 may further use an ink other than the shaping material ink to form the interior region 302 by, for example, simultaneously using the ink jet head other than the ink jet head 102mo. Moreover, in the variant of the configuration of the shaping device 10, for example, consideration is also made to forming the interior region 302 with the white ink and the like discharged from the ink jet head 102w (see FIGS. 1A and 1B) without using the ink jet head 102mo. In this case, the interior region 302 and the light reflecting region 304 may not be distinguished, and a region combining both regions may be formed.

The light reflecting region 304 may be a region having light reflecting property formed using the ink having light reflecting property. In the present example, the shaping device 10 forms the light reflecting region 304 by, for example, forming the layer of white ink discharged from the ink jet head 102w in an overlapping manner. In such a case, the shaping device 10 forms the light reflecting region 304 so as to surround the periphery of the interior region 302, as shown in the figure. More specifically, in the present example, the shaping device 10 forms the light reflecting region 304 so as to surround the entire outer side of the interior region 302.

In order to shape the colored 3D object 50, the light reflecting region 304 does not necessarily need to be formed so as to surround the entire outer side of the interior region 302, and the light reflecting region 304 may be formed at one part on the outer side of the interior region 302. In this case, the light reflecting region 304 is preferably formed at a portion to become the inner side (interior side) of the position for forming at least the coloring region 306. According to such configuration, for example, the full color representation by the subtractive color mixing method can be appropriately carried out. The colored 3D object 50, for example, thus can be appropriately shaped.

The thickness of the light reflecting region 304 is preferably formed to an even thickness of, for example, about 100 μm to 1 mm. In this case, the thickness of the region is, for example, the thickness in a normal direction perpendicular to the surface of the 3D object 50. In the present example, the shaping device 10 forms the light reflecting region 304 using only the white ink. In a variant of the configuration of the shaping device 10, for example, when carrying out the shaping at a higher speed, consideration is also made to further using the clear ink other than the white ink to form the light reflecting region 304.

The coloring region 306 is a region where coloring is performed in the surface of the 3D object 50. In this case, the surface of the 3D object 50 is, for example, the portion where the hue can be externally identified in the 3D object 50. In the present example, the coloring region 306 is a region where colors other than black can be colored. Furthermore, the coloring region 306 is an example of a region colored using the material for coloring of a chromatic color.

Moreover, the shaping device 10 forms a layer of ink colored in a desired color using, for example, the ink of each color of YMCK discharged from the ink jet heads 102y to 102k (see FIGS. 1A and 1B) and the clear ink discharged from the ink jet head 102t (see FIGS. 1A and 1B). Such layers of ink are formed in an overlapping manner to form the coloring region 306.

When configured in such manner, for example, the amount of change in the usage amount of the YMCK ink caused by the difference in the color to represent can be compensated by using the clear ink in addition to the ink of each color of YMCK. Thus, for example, the respective layers of ink configuring the coloring region 306 can be appropriately formed to a constant thickness. Therefore, according to the present example, for example, the full color representation can be more appropriately carried out. The thickness of the coloring region 306 is preferably formed to an even thickness of, for example, about 50 μm to 500 μm (e.g., about 300 μm). The thickness of the coloring region 306 may, for example, be smaller than 250 μm. Furthermore, in order to more appropriately enhance the resolution of the image drawn by coloring, for example, the thickness is preferably made to be smaller than or equal to 150 μm.

Furthermore, in the present example, the controller 20 causes the plurality of ink jet heads in the head unit 12 to form the coloring region 306 on the outer side of at least one part of the light reflecting region 304. In this case, more specifically, the controller 20 forms the coloring region 306 with respect to the position other than the portion where the black region 308 is to be formed in the surface of the 3D object 50. Thus, the plurality of ink jet heads are caused to form the coloring region 306 so as to cover the entire outer side of the light reflecting region 304 with the black region 308.

The black region 308 is a region colored in black in the surface of the 3D object 50. In this case, when referring to the black region 308 being colored in black, this means for example, that the coloring is carried out so as to fill the region in black under a condition different from when one part of the coloring region 306 is colored in black. Thus, the black region 308 may, for example, be a region of one part specified by the user or the shaping data of the portion colored in black in the 3D object 50. Furthermore, the black region 308 is an example of a region colored in black using a black material. The black region 308 may, for example, be a region where a portion of greater than or equal to a predetermined area in the surface is filled in black.

Moreover, in the present example, black merely needs to be, for example, substantially black according to the demanded accuracy of coloring. More specifically, in the present example, the black region 308 is a region colored in piano black. In this case, the piano black is, for example, a shiny deep black. On the contrary, when more generally considered, black can be considered as, for example, an achromatic color having light absorbing property. Thus, the black region 308 can also be considered as a light absorbing region formed with a material having light absorbing property.

Next, features, and the like of the black region 308 in the present example will be described in further detail. FIG. 2B is a view describing features, and the like of the black region 308 in further detail. As also described above, in the present example, the shaping device 10 forms the coloring region 306 and the black region 308 in at least one part of the surface of the 3D object 50. In this case, the coloring region 306 and the black region 308 are formed such that the thickness in the normal direction becomes equal at the outer side of the light reflecting region 304.

In this case, the shaping device 10 further forms the black region 308 divided into a plurality of regions in the normal direction, as shown in the figure. In this case, the thickness of the black region 308 in the normal direction is the thickness of the region in which the plurality of regions are combined. More specifically, in the present example, the shaping device 10 forms the black region 308 divided into two regions, an inner side region 312 and a surface side region 314.

The inner side region 312 is a region on the inner side in the region configuring the black region 308. The inner side region 312 is an example of a first region, and is colored in black by being formed using at least the black ink. Furthermore, more specifically, in the present example, the controller 20 of the shaping device 10 causes the ink jet head 102k to form the black inner side region 312. The inner side region 312 is thus formed with only the black ink. In a variant of the configuration of the shaping device 10, for example, the inner side region 312 may be formed using the black ink and the clear ink.

The surface side region 314 is a region on the outer side in the region configuring the black region 308. The surface side region 314 is an example of a second region, and is formed such that the transmittance of light becomes higher than the inner side region 312 by being formed using at least the clear (CL) ink, and covers the inner side region 312 from the outer side. Furthermore, more specifically, in the present example, the controller 20 causes the ink jet head 102t to form the colorless transparent surface side region 314. The surface side region 314 is thus formed with only the clear ink.

When configured in such manner, for example, the transparent surface side region 314 is formed on the surface side of the 3D object 50 in the black region 308, so that the light can enter inside, to a certain extent, of the black region 308 while preventing the light from being absorbed with only the surface of the black region 308. Furthermore, the light entering through the surface side region 314 can be appropriately and sufficiently absorbed by forming the inner side region 312 colored in black on the inner side of the surface side region 314. Thus, the black can be appropriately represented.

Thus, in the present example, the black can be appropriately represented while allowing the light to enter the inside of the black region 308 to a certain extent. Thus, according to the present example, for example, a deep black can be more appropriately represented in the black region 308.

The thickness of the surface side region 314 in the normal direction is, for example, preferably greater than or equal to 30 μm. According to such configuration, for example, the light can sufficiently enter the black region 308. Thus, the deep black can be more appropriately represented. Furthermore, the thickness of the surface side region 314 in the normal direction is more preferably greater than or equal to 60 μm. The thicknesses of the surface side region 314 and the inner side region 312 may be differed from each other. In this case, with respect to the thickness in the normal direction, the black inner side region 312 is preferably made thicker than the surface side region 314. According to such configuration, the entered light can be more reliably absorbed in the black region 308. Thus, for example, the dark black can be more appropriately represented.

An appropriately and sufficiently dark black ink is preferably used for the black ink to use for the formation of the inner side region 312, and the like to, for example, represent black of sufficient depth with only the inner side region 312 formed at one part of the black region 308. More specifically, for example, an ink containing a black pigment for a color material can be suitably used for the black ink. According to such configuration, the dark black can be more appropriately represented.

FIG. 2C is a view describing the configuration of the black region 308 in further detail, and shows one example of a state of the black region 308 at a position where the normal direction becomes parallel to the layering direction (Z direction) in a simplified manner with the surrounding coloring region 306. As also described above, in the present example, the shaping device 10 shapes the 3D object 50 through the layering and shaping method. In this case, the layer of ink corresponding to each piece of slice data is formed in an overlapping manner based on a plurality of pieces of slice data corresponding to the cross-section of each position of the 3D object 50 to shape the 3D object 50.

For example, in the present example, the shaping device 10 forms the inner side region 312 in the black region 308 by overlapping a layer 402 of ink formed with the black ink. Furthermore, the surface side region 314 in the black region 308 is formed by overlapping a layer 404 formed with the clear ink. Furthermore, the coloring region 306 is formed by overlapping a layer 406 of ink formed with the ink of each color of YMCK and the clear ink. In this case, the layer 402, the layer 404, and the layer 406 are a region in one layer of ink formed in correspondence with one piece of slice data. According to such configuration, each region configuring the 3D object 50 can be appropriately formed.

In FIG. 2C, a state of the black region 308, and the like at the position where the normal direction becomes parallel to the layering direction is shown. Thus, in this case, the thickness in the normal direction of each region becomes the thickness in the layering direction. As a result, the thickness of each region in the normal direction becomes proportional to the number of layers layered. In this case, the thickness of the inner side region 312 in the normal direction is preferably, for example, a thickness of greater than or equal to about three layers (e.g., about three to five layers) of the layer 402 of ink. According to such configuration, for example, by the inner side region 312, black can be appropriately represented.

Furthermore, in this case, the thickness of the surface side region 314 in the normal direction is preferably, for example, a thickness of about two layers (e.g., about one to two layers) of the layer 404 of ink. According to such configuration, for example, the light can appropriately enter the black region 308. Thus, for example, the deep black can be more appropriately represented.

Furthermore, in the 3D object 50, for example, the black region 308 and the like are sometimes formed at a position where the normal direction does not become parallel to the layering direction. In such a case as well, the black region 308 including the inner side region 312 and the surface side region 314 lined in the normal direction is formed. In such a case, the inner side region 312 and the surface side region 314 are preferably formed such that the thickness in the normal direction becomes similar to the above. According to such configuration, for example, a deep black can be appropriately represented even in the black region 308 at the position where the normal direction does not become parallel to the layering direction.

Furthermore, in the description made above, a case of forming the inner side region 312 in the black region 308 only with the black ink and forming the surface side region 314 only with the clear ink has been mainly described. However, in a variant of the 3D object 50 shaped by the shaping device 10, the inner side region 312, the surface side region 314, and the like may be formed with a configuration different from the above.

For example, when the thickness of the inner side region 312 can be sufficiently ensured, and the like, consideration is made to reducing the depth per unit thickness and forming the inner side region 312, and the like. In this case, for example, the inner side region 312 may be formed by further using the clear ink in addition to the black ink. In this case as well, the dark black can be appropriately represented with the entire inner side region 312 by forming the inner side region 312 with a sufficient thickness. Furthermore, in this case, for example, use of an ink containing a black dye for a color material, and the like is considered.

The surface side region 314 may also be formed with light black, for example, rather than being formed completely transparent. In this case, for example, consideration is made to forming the surface side region 314 colored to a lighter black than the inner side region 312. When configured in such manner as well, for example, the black can be appropriately represented while allowing the light to enter the inside of the black region 308 to a certain extent. Thus, for example, the deep black can be more appropriately represented in the black region 308.

More specifically, in this case, for example, the surface side region 314 colored to a lighter black than the inner side region 312 is formed by forming the surface side region 314 using the black ink and the clear ink. Furthermore, consideration is made to, for example, forming each of the inner side region 312 and the surface side region 314 using the black ink and the clear ink, and increasing the content ratio of the clear ink in the surface side region 314 than that in the inner side region 312, and the like. Furthermore, consideration is made, for example, to coloring the surface side region 314 with a substantial black represented with a mixed color of Y (yellow), M (magenta), and C (cyan), rather than with the black colored with the black ink.

In the description made above as well, the black region 308 is a region colored to a piano black in the present example. On the contrary, the way the black represented by the black region 308 is seen changes, for example, depending on whether shiny or not, as well. The shininess of the color is greatly influenced by, for example, the state of the surface of the 3D object 50. Thus, for example, when representing shiny black such as piano black, and the like, the surface of the 3D object 50 in the region where at least the black region 308 is formed is preferably formed in a glossy smooth state. Furthermore, a matted black, and the like is sometimes desirably represented, other than the shiny black such as the piano black, for the deep black. In such a case, the surface of the 3D object 50 is considered to be formed in the matted state.

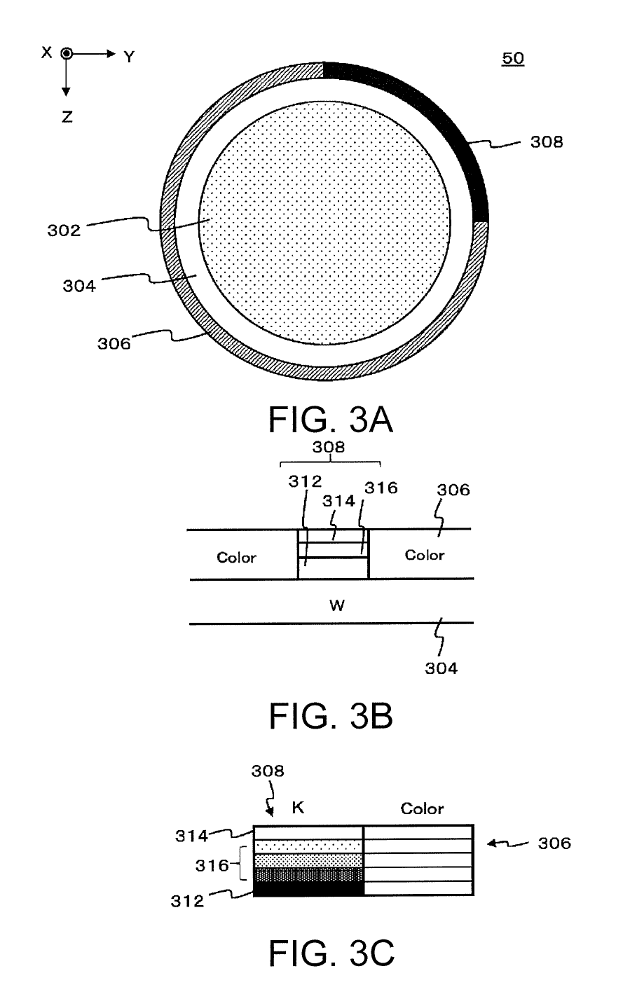

Next, supplementary explanation, description of a variant, and the like will be made for a feature of the 3D object 50 shaped in the present example. FIGS. 3A to 3C are views describing a feature of the 3D object 50 in further detail. Excluding the points described below, the configuration denoted with the same reference numeral as FIGS. 1A to 2C in FIGS. 3A to 3C may have a feature same as or similar to the configuration in FIGS. 1A to 2C.

FIG. 3A shows another example of a configuration of the 3D object 50 shaped by the shaping device 10. In FIG. 2A, the 3D object 50 in which the outer peripheral surface has a planar shape is illustrated for the sake of convenience of illustration and explanation. In this case, the normal direction of the 3D object 50 is a direction perpendicular to the plane configuring the outer peripheral surface.

However, the shaping device 10 is not limited to shaping the 3D object 50 in which the outer peripheral surface has a planar shape, and may shape the 3D object 50 of various shapes. For example, in FIG. 3A, one example of a configuration is illustrated for the 3D object 50 having a spherical shape. In such a case, the outer peripheral surface of the 3D object 50 is a curved surface. Furthermore, the normal direction of the 3D object 50 is a direction orthogonal to the surface at each position of the 3D object 50. In this case as well, the deep black can be appropriately represented by forming the black region 308 divided into a plurality of regions in a manner same as or similar to the case described using FIG. 2 and the like.

Furthermore, in a variant of a shaping operation of the shaping device 10, consideration is made to further forming a region other than each region described above for the region configuring the 3D object 50, and the like. More specifically, for example, consideration is made to forming a separation region between the light reflecting region 304 and the coloring region 306, and the like. In this case, the separation region is, for example, a transparent region formed with the clear ink, and prevents the white ink configuring the light reflecting region 304 and the ink of each color configuring the coloring region 306 from mixing. In this case, the separation region is also preferably formed between the black region 308 and the interior region 302.

Furthermore, for example, consideration is made to further forming a transparent protective region on the outer side of the coloring region 306 and the black region 308, and the like. In this case, the protective region is, for example, a transparent region formed with the clear ink, and protects the coloring region 306 and the black region 308 by covering the outer side of the coloring region 306 and the black region 308.

In this case, a deeper impression can be provided, and the like for the black represented with the black region 308 by forming the transparent region that covers the outer side of the black region 308. Furthermore, for example, the shiny black such as the piano black can be more appropriately represented by forming the surface of the protective region in a glossy smooth state.

Furthermore, consideration is made to forming the transparent region that covers the outer side of the black region 308 with a method (clear coat) such as painting, for example, rather than forming the relevant region at the time of shaping with the shaping device 10. In this case, for example, consideration is made to enhancing a thickness (depth) feeling by forming the surface side region 314 in the black region 308 to represent the deep black, and then having the paint (overcoat) covering the surface of the 3D object 50 to be a glossy form with a transparent material. According to such configuration, for example, the smoothness of the surface of the 3D object 50 can be appropriately enhanced. Thus, for example, the shiny black such as piano black can be appropriately represented. Furthermore, for example, consideration is also made to carrying out a matted painting (mat painting) by a transparent material with respect to the surface of the 3D object 50 depending on the quality demanded on the 3D object 50.

In the description made above, a configuration of when forming the black region 308 by dividing it into two regions, the inner side region 312 and the surface side region 314, and the like has been mainly described for the configuration of the black region 308. However, the black region 308 may be divided into a greater number of regions in the normal direction.

FIG. 3B shows a variant of the configuration of the 3D object 50. In this case, the shaping device 10 further forms an intermediate region 316 sandwiched by the inner side region 312 and the surface side region 314 as a region configuring the black region 308. Thus, the black region 308 divided into the inner side region 312, the intermediate region 316, and the surface side region 314 in the layering direction is formed.

In this case, the intermediate region 316 is, for example, formed with black lighter than the inner side region 312. Thus, the transmittance of the light with respect to the intermediate region 316 is made to have a transmittance higher than the inner side region 312 and lower than the surface side region 314. More specifically, in this case, the controller 20 (see FIGS. 1A and 1B) of the shaping device 10 causes the ink jet head 102k and the ink jet head 102t (see FIGS. 1A and 1B) to discharge ink to form the intermediate region 316 with the black ink and the clear ink.

When configured in such manner, the color of the black region 308 is changed to a gradation form such that the color becomes lighter in the inner side region 312, the intermediate region 316, and the surface side region 314 in such order. According to such configuration, for example, the depth of the color in the normal direction in the black region 308 can be changed more naturally. Thus, for example, the deep black can be more appropriately represented.

Furthermore, in this case, a plurality of intermediate regions 316, each having a different depth, may be formed between the inner side region 312 and the surface side region 314. In this case, the density of black of each intermediate region 316 is preferably set such that the density of black gradually lowers from the inner side toward the outer side.

FIG. 3C is a view showing a further variant of the configuration of the 3D object 50, and shows one example of a configuration of when forming a plurality of intermediate regions 316 between the inner side region 312 and the surface side region 314, and changing the density of black in a gradation form. According to such configuration, for example, the deep black can be more appropriately represented.

In FIG. 3C, a configuration of when forming each of the inner side region 312 and the surface side region 314 with one layer of ink is illustrated for a portion where the normal direction becomes parallel to the layering direction. In this case, the thickness in the normal direction of each of the inner side region 312 and the surface side region 314 is the thickness for one layer of ink. Furthermore, each of the inner side region 312 and the surface side region 314 may be formed by, for example, forming a plurality of layers of ink and having the thickness in the normal direction equal to the thicknesses of the plurality of layers of ink.

In FIG. 3C, one layer of ink is also formed for the respective intermediate regions 316. Thus, the thickness in the normal direction of one intermediate region 316 is also the thickness for one layer of ink. Furthermore, each intermediate region 316 may be formed, for example, such that the thickness in the normal direction becomes equal to the thicknesses of the plurality of layers of ink.

In the black region 308 formed at the position where the normal direction does not become parallel to the layering direction as well, the thickness in the normal direction of each region may be formed similar to the above. Moreover, when considering changing the density of black in the black region 308 to a gradation form in a more generalized manner, for example, one portion on the inner side in the black region 308 may be considered as the inner side region 312. Furthermore, for example, one portion on the outer side may be considered as the surface side region 314.

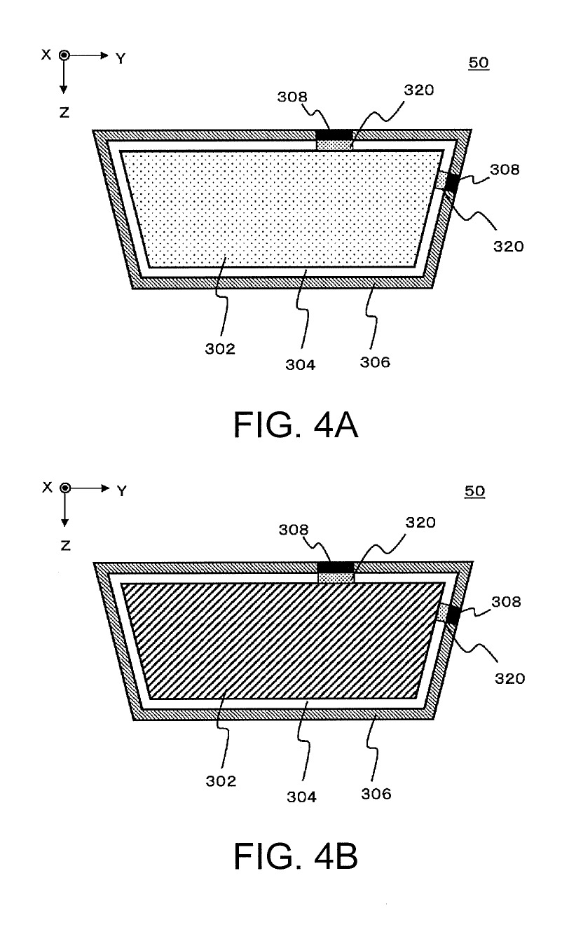

Furthermore, the configuration of the 3D object 50 shaped by the shaping device 10 can be further variously deformed. FIGS. 4A and 4B are views describing a further variant of the configuration of the 3D object 50. Excluding the points described below, the configuration denoted with the same reference numeral as FIGS. 1A to 3C in FIGS. 4A and 4B may have a feature same as or similar to the configuration in FIGS. 1A to 3C.

FIG. 4A shows a further variant of the configuration of the 3D object 50. In the description made above, a configuration of when forming both the coloring region 306 and the black region 308 on the outer side of the light reflecting region 304 has been mainly described. However, when attempting to more appropriately represent black in the black region 308, it is sometimes preferable not to form light reflecting region 304 on the inner side of the black region 308. Thus, the light reflecting region 304 may be formed only at the portion to become the inner side of the coloring region 306 without being formed at the portion to become the inner side of the black region 308.

In such a case, a region 320 separate from the light reflecting region 304, as shown in the figure, for example, is formed between the interior region 302 and the black region 308. Consideration is made, for example, to forming a transparent region using the clear ink for the region 320. According to such configuration, for example, a deep dark black can be more appropriately represented in the black region 308.

For example, consideration is made to forming the region 320 to black using the black ink. In this case, a portion combining the black region 308 and the region 320 becomes a continuous black region. Furthermore, such black region becomes a region that is thick in the normal direction than the surrounding coloring region 306. According to such configuration, for example, the deep dark black can be more appropriately represented.

Furthermore, in order to more appropriately represent a deep dark black in the black region 308 and the like, for example, it is sometimes preferable to also consider the color of the interior of the 3D object 50. More specifically, for example, when shaping the 3D object 50 of a small size or when forming the 3D object 50 including a thin portion, the light entering from the back side of the 3D object 50 with respect to a line of sight of observing the 3D object 50 may be transmitted through the 3D object 50 thus influencing the way the color of the 3D object 50 is seen. Thus, in a further variant of the configuration o f the 3D object 50, consideration is also made to using a configuration that can more appropriately suppress the influence of the transmitted light, and the like.

FIG. 4B is a view showing a further variant of the configuration of the 3D object 50, and shows an example of a configuration of when the color of the interior of the 3D object 50 is a color having light absorbing property. In this case, the controller 20 (see FIGS. 1A and 1B) causes the plurality of ink jet heads in the head unit 12 (see FIGS. 1A and 1B) to form the interior region 302 with the color having light absorbing property. Each region such as the coloring region 306, the black region 308, and the like is formed on the outer side of the interior region 302. The 3D object 50 is thereby shaped with a configuration (wrapping method) as if wrapping a black bean paste inside.

Furthermore, in this case, the light reflecting region 304 is preferably formed only at the portion to become the inner side of the coloring region 306 without being formed at the portion to become the inner side of the black region 308, similar to the case described using FIG. 4A. More specifically, in the case of the illustrated configuration, the region 320 is formed between the interior region 302 and the black region 308 by, for example, clear ink, black ink, or the like.

When configured in such manner, for example, the influence of the light passing through the interior of the 3D object and exiting to the opposite side can be appropriately suppressed by forming the interior region 302 with the color having light absorbing property. Thus, for example, the deep dark black can be more appropriately represented in the black region 308. Furthermore, in this case, the influence of the color, and the like on the back surface side of the 3D object 50 can be appropriately suppressed even for the coloring region 306. Thus, various colors can be more appropriately represented even for the coloring region 306.

In the relevant configuration, the interior region 302 is preferably formed in black, for example. According to such configuration, for example, the interior region 302 having light absorbing property can be appropriately formed. In this case, for example, consideration can be made to forming the interior region 302 using the ink jet head 102k (see FIGS. 1A and 1B) for the black ink. Furthermore, the color of the interior region 302, for example, may be colored to a substantial black represented with a mixed color of Y (yellow), M (magenta), and C (cyan) rather than to the black colored with the black ink. In this case, for example, the interior region 302 is formed using the ink jet heads 102y to 102k (see FIGS. 1A and 1B) for each color of YMC. In this case, the ink jet head 102k, and the like may be further used to form the interior region 302. Furthermore, when using the ink jet head 102mo (see FIGS. 1A and 1B) for the shaping material ink, as in the head unit 12 described using FIGS. 1A and 1B and the like, consideration is also made to using the shaping material ink of a color having light absorbing property such as black.

Now, a further variant of the configuration, and the like of the shaping device 10 will be described. In the description made above, a case of forming the black region 308 using the black ink used as one of the process colors used for color representation has been mainly described above. However, in a variant of the configuration of the shaping device 10, a black ink to use for the formation of the black region 308 may be further used apart from the black ink of the process color.

In the description made above, a case of having the thickness in the normal direction equal in the black region 308 and the coloring region 306 has been mainly described. However, the thickness of the black region 308 in the normal direction may be, for example, differed from the coloring region 306. In this case, for example, the black region 308 is preferably formed to be thicker than the coloring region 306. In this case, it is preferable to differ the thickness of the light reflecting region 304 between the inner side of the black region 308 and the inner side of the coloring region 306 according to the difference in thickness of the black region 308 and the coloring region 306. Furthermore, the black region 308 may be formed to a thickness equal to the thickness of the light reflecting region 304 and the coloring region 306 combined without forming the light reflecting region 304 on the inner side of the black region 308.

When considering the feature of the present example in a more generalized manner, consideration is also made to representing a deep color for not only black but also for other colors having light absorbing property according to the configuration similar to the present example. In this case, the color having light absorbing property is, for example, colors such as a color obtained by mixing one of the chromatic colors and black, a dark gray, and the like. Furthermore, the light having light absorbing property may be a color of low intensity. Even in such a case, a deep color can be represented by forming a region corresponding to the inner side region 312 using other colors having light absorbing property in place of black for the region of a color having light absorbing property corresponding to the black region 308, and forming the surface side region 314 on the outer side thereof.

### INDUSTRIAL APPLICABILITY

The present disclosure can be suitably used for, for example, the shaping device.

What is claimed is:

1. A shaping device that shapes a three-dimensional object, the shaping device comprising:
a plurality of discharging heads that each discharges a material of shaping; and
a controller that controls operations of the plurality of discharging heads, wherein
the plurality of discharging heads include at least
a black material head that discharges a black material; and
a translucent material head that discharges a material having translucency,
the controller causes the plurality of discharging heads to form a black region colored in black using the black material in at least one part of a portion where a hue is externally identifiable in the three-dimensional object,
and the black region includes:
a first region colored in black using the black material; and
a second region covering the first region from an outer side, being a region having a higher transmittance of light than the first region and formed using at least the material having translucency.

2. The shaping device according to claim 1, further comprising a coloring material head that discharges a material for coloring of a chromatic color for the discharging head, wherein
the controller causes the plurality of discharging heads to further form a coloring region colored using the material for coloring in at least one part of a portion where a hue is externally identifiable in the three-dimensional object; and
makes a thickness of the coloring region equal to a thickness of the black region with respect to a thickness in a normal direction perpendicular to a surface of the three-dimensional object.

3. The shaping device according to claim 2, further comprising a light reflecting material head that discharges a material having light reflecting property for the discharging head, wherein the controller
uses at least the light reflecting material head to form a light reflecting region, which is a region having light reflecting property; and
causes the plurality of discharging heads to form the coloring region on an outer side of at least one part of the light reflecting region.

4. The shaping device according to claim 3, wherein the controller causes the plurality of discharging heads to form the black region in at least one part of a portion not formed with the coloring region in an outer side of at least one part of the light reflecting region.

5. The shaping device according to claim 1, wherein
the translucent material head discharges a clear ink as a material having translucency, and
the controller causes the translucent material head to form the second region which is colorless and transparent.

6. The shaping device according to claim 1, wherein the controller causes the plurality of discharging heads to form the second region colored to a lighter black than the first region.

7. The shaping device according to claim 1, wherein
the black region further includes an intermediate region, which is a region sandwiched between the first region and the second region, and
the controller causes the black material head and the translucent material head to form the intermediate region such that a transmittance of light with respect to the intermediate region becomes higher than a transmittance of the first region and lower than a transmittance of the second region.

8. The shaping device according to claim 1, wherein the first region is thicker than the second region with respect to a thickness in a normal direction perpendicular to a surface of the three-dimensional object.

9. The shaping device according to claim 1, wherein a thickness of the second region in a normal direction perpendicular to a surface of the three-dimensional object is greater than or equal to 40 μm.

10. The shaping device according to claim 1, wherein the black region is a region colored to piano black.

11. The shaping device according to claim 4, wherein
the translucent material head discharges a clear ink as a material having translucency, and
the controller causes the translucent material head to form the second region which is colorless and transparent.

12. The shaping device according to claim 4, wherein the controller causes the plurality of discharging heads to form the second region colored to a lighter black than the first region.

13. The shaping device according to claim 4, wherein
the black region further includes an intermediate region, which is a region sandwiched between the first region and the second region, and
the controller causes the black material head and the translucent material head to form the intermediate region such that a transmittance of light with respect to the intermediate region becomes higher than a transmittance of the first region and lower than a transmittance of the second region.

14. The shaping device according to claim 4, wherein the first region is thicker than the second region with respect to a thickness in a normal direction perpendicular to a surface of the three-dimensional object.

15. The shaping device according to claim 4, wherein a thickness of the second region in a normal direction perpendicular to a surface of the three-dimensional object is greater than or equal to 40 μm.

16. The shaping device according to claim 4, wherein the black region is a region colored to piano black.

17. The shaping device according to claim 1, wherein the controller causes the plurality of discharging heads to further form an interior region formed with a color having light absorbing property, the region configuring an interior of the three-dimensional object, and to form the black region on an outer side of the interior region.

18. A shaping device that shapes a three-dimensional object, the shaping device comprising:
a plurality of discharging heads that each discharges a material of shaping; and
a controller that controls operations of the plurality of discharging heads, wherein
the plurality of discharging heads include at least:
a light absorbing material head that discharges a material having light absorbing property; and
a translucent material head that discharges a material having translucency,
the controller causes the plurality of discharging heads to form a light absorbing region colored to a color having light absorbing property using the material having light absorbing property in at least one part of a portion where a hue is externally identifiable in the three-dimensional object; and
the light absorbing region includes
a first region colored to the color having light absorbing property using the material having light absorbing property; and
a second region covering the first region from an outer side, being a region having a higher transmittance of light than the first region and formed using at least the material having translucency.

19. A shaping method for shaping a three-dimensional object, at least a black head that discharges a black material, and a translucent material head that discharges a material having translucency being used for a plurality of discharging heads that each discharges a material of shaping;
the method comprising causing the plurality of discharging heads to form a black region colored in black using the black material in at least one part of a portion where a hue is externally identifiable in the three-dimensional object, and
the black region includes:
a first region colored in black using the black material; and
a second region covering the first region from an outer side, being a region having a higher transmittance of light than the first region and formed using at least the material having translucency.

20. A shaping method for shaping a three-dimensional object, at least a light absorbing material head that discharges a material having light absorbing property and a translucent material head that discharges a material having translucency being used for a plurality of discharging heads that each discharges a material of shaping,
the method comprising causing the plurality of discharging heads to form a light absorbing region colored to a color having light absorbing property using the material having light absorbing property in at least one part of a portion where a hue is externally identifiable in the three-dimensional object; and
the light absorbing region includes:
a first region colored to the color having light absorbing property using the material having light absorbing property; and
a second region covering the first region from an outer side, being a region having a higher transmittance of light than the first region and formed using at least the material having translucency.
